(19) United States
(12) Patent Application Publication
(10) Pub. No.: US 2008/0246304 A1
(43) Pub. Date: Oct. 9, 2008

(54) Weatherstrip with Ventilation Openings

(75) Inventors: Jens Huttebraucker, Hildesheim (DE); Paavo Zelazo, Marienhagen (DE)

Correspondence Address: SYNNESTVEDT & LECHNER, LLP, 1101 MARKET STREET, SUITE 2600, PHILADELPHIA, PA, 19107-2950, US

(73) Assignee: Meteor Gummiwerke K. H. Badje GmbH & Co. KG, Bockenem (DE)

(21) Appl. No.: 11/908,445

(22) PCT Filed: Dec. 21, 2005
(86) PCT No.: PCT/EP2005/013750

§ 371 Date: Sep. 12, 2007

(30) Foreign Application Priority Data
Mar. 12, 2005 (DE) 20 2005 004 006.1

(51) Int. Cl. B60J 10/08

(52) U.S. Cl. 296/146.9

(57) ABSTRACT

A weatherstrip intended for positioning on the flange of the edge of the opening of a vehicle consists of a side-by-side arrangement of a tubular sealing section (1), a U-shaped fastening section (2) and a strip (3) laterally formed on the fastening section (2), which together with a limb (2′) of the fastening section (2) circumscribes a cavity (9″) which is open toward the underside (1′) of the weatherstrip. The cross-sectional profile of the sealing section (1) is partially formed by the limb (2′″) of the fastening section (2) facing said sealing section, ventilation holes (18) located on the underside of the weatherstrip facing the aforementioned edge, forming a region of the sealing section (1) of greatest wall thickness. By this arrangement of the ventilation opening is the advantage that, as a result, there is almost no negative influence on the flexural rigidity of the cross-sectional profile, so that the weatherstrip may also be placed along small radii of curvature, without the risk of the profile collapsing. As the ventilation openings are located on an underside facing the edge, this also results in no negative influence on the visual appearance.

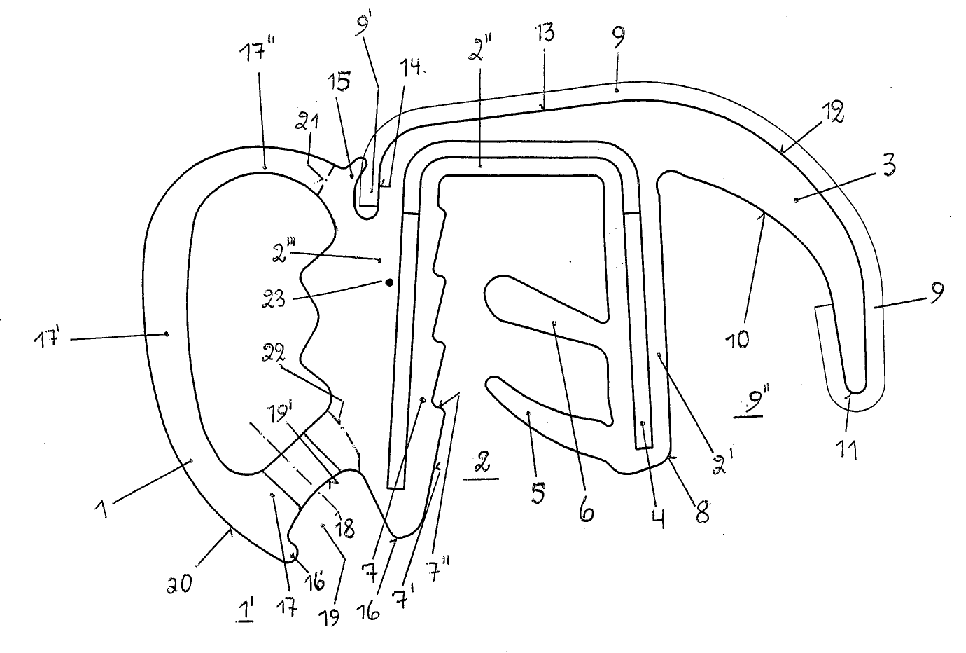

The invention relates to a weatherstrip according to the preamble of claim 1.

Weatherstrips, which are made up of the side-by-side arrangement of a hollow profiled and/or tubular sealing section and a U-shaped fastening section, intended for positioning on a peripheral flange, for example a door frame of a motor vehicle, are known as such in the firm of the applicant.

The fastening section is principally configured with regard to a fit which is designed to be reliable relative to an inadvertent release from the flange, whilst the weatherstrip frequently also has to fulfill damping functions, by forming a buffer zone between metal components, for example a door frame and a door edge, which are movably arranged relative to one another. In the closed state of the door, the sealing section is elastically deformed and, in terms of material and shape, said sealing section should be configured with the provision that stable elastic recovery is provided over time and namely within conventional temperatures resulting from the operation of the vehicle. For fulfilling a damping function, the hollow profile of the sealing section is generally provided with, amongst others, ventilation openings which are provided along the extension thereof in a uniform distribution.

With every closing and opening action of the door, air exchange is possible via said ventilation openings between the interior of the hollow profile and the exterior, upon which, amongst others, the damping effect of the sealing section rests. By means of said ventilation openings, moreover, condensation is reliably prevented from collecting, for example when the interior of the sealing section is subjected to changing temperatures.

A negative influence on the mechanical stability of the cross-sectional profile of the sealing section, however, is generally produced by the ventilation openings. This has an effect, in particular when placing the weatherstrip along small radii of curvature, such as for example in the region of door corners and the like and may, in an extreme case, lead to a complete collapse of the cross-sectional profile. A locally collapsed sealing section is, nevertheless, only able to fulfill its sealing and damping function extremely unsatisfactorily.

It is also known, in the firm of the applicant, to arrange the aforementioned ventilation openings in a region which is visible in the installed state of the weatherstrip. It is disadvantageous, in this case, that in this manner not only a penetration of dirt into the structure of the sealing section is facilitated. The ventilation openings which are, for example, circular in the initial state are always more or less deformed into a very ovoid shape depending on the curvatures along which they are placed in the installed state and may, in an extreme case, be exceptionally distorted depending on the respective radius of curvature. This circumstance leads not only to a very negative external appearance of the weatherstrip—depending on the local distortion which is present as a result of uneven tension distribution, excessive mechanical stress is also provided locally which reduces the life of said component.

With this background, it is the object of the invention to improve a weatherstrip of the type described at the beginning with regard to a design which, relative to the aforementioned prior art, is more appropriate for the stresses, so that a trouble-free placement of such weatherstrips is possible even with small radii of curvature. With such a weatherstrip, this object is achieved by the features of the characterizing part of claim 1.

Accordingly, it is essential to the invention that the cross-sectional profile of the sealing section is partially formed by the one facing limb of the fastening section. The limb of the fastening section, together with other cross-sectional sections, completes the entire hollow profile of the sealing section. This means that the fastening section indirectly contributes to the flexural rigidity of the cross-sectional profile of the sealing section, which in the installed state is curved in the same plane. After the U-shaped fastening section is positioned on a peripheral flange and is fixed thereby, the common wall section of the fastening section and the sealing section have a considerable additional reinforcing effect on the flexural rigidity of the sealing section, which to a significant extent contributes to preventing a collapse of the cross-sectional profile of the sealing section, even when placed along small radii of curvature. In this connection, it is essential that the part of the cross-sectional profile of the sealing section which faces the aforementioned limb of the fastening section, is rigidly connected thereto along its entire contact surface. The ventilation openings are located on the side facing the underside of the weatherstrip and in a region of greatest wall thickness of the cross-sectional profile of the sealing section. As the ventilation openings are already located in a region of large wall thickness, a weakening influence of the ventilation openings which is otherwise present is reduced to a minimum. It is also advantageous that—viewed in the installed state—the ventilation openings on the underside are, therefore, located in a position which is not visible and accordingly does not impair the entire appearance of the installed weatherstrip. The ventilation openings could, therefore, fulfill their function without having a negative influence on the function of the weatherstrip.

The features of claim 2 have the advantage that the extent of the wall thickness of the sealing section may be adjusted in structural terms, such that a sufficient elastic deformability is provided and at the same time the ventilation openings have no negative influence on the stability of the cross-sectional profile of the sealing section.

The features of claim 3 firstly provide the advantage that, as regards the design, without a substantially greater use of materials, the stability of the design of the sealing section is improved, by a U-shaped recess being formed on the underside of the weatherstrip which, on the one hand, is formed by a rib formed on the sealing section and, on the other hand, by the limb of the fastening section facing the sealing section. Said design has the effect of increasing the stability with regard to bending about an axis located in a cross-sectional plane of the sealing section. Moreover, as the ventilation openings are arranged in the profile base of said recess, said ventilation openings are always arranged at a position which is hardly visible and/or not visible at all. This is, therefore, a further measure to provide an advantageous appearance of the weatherstrip in the installed state.

According to the features of claim 4, on the fastening section and namely on the side thereof opposing the sealing section, a strip is formed which together with the facing limb of the fastening section circumscribes a cavity which is open toward the underside of the weatherstrip. Said strip mainly fulfills the function of a cover panel and said cover panel may be covered externally by a textile cover or may be treated decoratively in any other manner.

The features of claims 5 and 6 are directed toward the material design of the fastening section and the strip. Accordingly, both may be produced from soft rubber, for example.

According to the features of claim 7, the U-shaped structure of the fastening section is provided with a preferably metal reinforcement. In a manner known per se, said reinforcement has the effect, firstly, of increasing the rigidity of the U-shaped structure of the fastening section and permits a relatively thin-walled design. By the choice of a suitable reinforcement, in particular a corresponding design, there is the possibility, moreover, of providing in a structural manner elastic restoring forces of the fastening section, which are required for a stable fit on a flange on which the fastening strip is positioned. Finally, a stabilizing effect on the cross-sectional profile of the fastening section results from the reinforcement, even with the generally expected spatial curvatures along which the edges of vehicle openings extend. The arrangement of a metal reinforcement is generally preferred—a reinforcement consisting of a suitable plastics material, having a high elastic resilience is, however, not excluded.

According to the features of claim 8, the sealing section consists at least partially of cellular rubber. For example, the sealing section may consist of a tubular hollow profile, which is rigidly connected along one part of its periphery to the facing side of the fastening section. In this manner, the influence of the fastening section determining the stability as well as the rigidity of the cross-sectional profile of the sealing section is ensured. Alternatively thereto, however, the facing limb of the fastening section, consisting of soft rubber, may directly form a wall section of the hollow profile of the sealing section, so that merely the remaining wall sections consist of cellular rubber.

In a manner known per se, the outer and/or visible region of the sealing section may be coated with lubricating lacquer or a coating having substantially the same effect. This measure substantially serves to reduce wear, with each closing and opening action of the door, following the resulting relative movements between the surface of the sealing section which, for example, is rigidly connected to the frame of a door opening and the metal structures of the doors opposing said frame.

It is recognized with reference to the aforementioned embodiments that in the new weatherstrip according to the invention a component is provided which may be handled even under difficult conditions, for example small radii of curvature, and which provides a sealing and damping profile which is appropriate to the function and/or stress, in addition to an attractive external appearance.

The invention is described in more detail hereinafter with reference to the profile of a weatherstrip reproduced in the drawings with reference to the cross section thereof.

Said profile consists of the side-by-side arrangement of a hollow profile-like sealing section 1, a U-shaped fastening section 2 and a strip 3 formed to the side thereof, principally forming a cover plate.

The fastening section 2 is provided with a similarly U-shaped metal reinforcement 4 and intended for positioning on a flange, not shown in the drawing, attached to the edge of the opening of a motor vehicle. For stabilizing the fit on this flange the fastening section 2 is provided on its inner face with flexible tongues 5, 6, which extend from the right-hand side limb 2′ with approximately parallel spacing from one another and—relative to the U-shaped profile of the fastening section 2—extend inwards in the direction of the profile base 2″. On the inside of the fastening profile 2—opposing the flexible tongues 5, 6—a saw tooth-like profile 7 is located, moreover, which consists of a series of flank sections 7′ rising in the direction of the profile base 2′ to which relatively short respective flank sections 7″ falling steeply are joined. The retaining effect from the flexible tongues 5, 6, in connection with the profile 7, exerted on the aforementioned flange is increased further by an elastic restoring force of the reinforcement 4, so that as a whole a reliable fit of the weatherstrip is provided. In particular, due to the orientation of the flexible tongues 5, 6 and the profile 7 relative to the profile base 2″ an inadvertent release of the weatherstrip from the flange is reliably prevented.

Formed to the side of the limb 2′ of the fastening section 2 is the aforementioned strip 3 which has a curved path in the direction of the end 8 on the underside of the right-hand limb. The strip 3 thus defines, together with the limb 2′, a cavity 9″ which is open toward the underside 1′ of the weatherstrip.

A textile laminate strip denoted by 9 which extends from the inside 10 of the strip 3, is guided around the free end 11 thereof and subsequently extends over the outer face 12 of the strip 3 and the adjacent bottom section 13 of the fastening section 2. It is connected to said surface sections 10, 12 in an appropriate manner.

The wall of the sealing section 1 is formed on the side facing the fastening section 2 directly by the limb 2′″ thereof, on the left-hand side in the drawing. Said limb comprises on its outer face a groove 14 extending approximately parallel to the limb, in which the end 9′ of the laminate strip 9 projects. A secure fit of the laminate strip is further ensured by a flexible tongue 15 which is formed at the entrance to the groove 14 and projects therein, so that said flexible tongue is elastically deflected in the assembled state of the laminate strip 12.

An essential feature of the remaining wall of the hollow profile of the sealing section 1 is a wall thickness which is markedly greater at its lower part, i.e. the part facing the free end 16 of the limb 2′″ of the fastening section 2. In such a wall section 17 facing the underside 1′ and extending upwards in the direction of the limb 2′″ relative to the underside 1′—viewed according to uniform spacings in the longitudinal direction of the weatherstrip—are located ventilation openings, generally ventilation holes 18.

It is recognized with reference to the aforementioned embodiments that said ventilation holes 18 in the assembled state of the weatherstrip are, in any case, not located in a visible region.

It is further recognized that said ventilation holes 17 are located in such wall sections which, relative to the remaining wall sections, are of reinforced design, with regard to their wall thickness, so that even when placing the weatherstrip in accordance with greater curvatures, a collapse of the hollow profile of the sealing part 1 is not encountered.

By the thick-walled design of the wall section 17, at least tending to be further increased by the forming of a rib 16′ which opposes the free end 16 and forms therewith on the underside a generally U-shaped recess 19, protection against a collapse of the sealing section 1 is provided in spite of the presence of ventilation holes 18.

The extent of the wall thickness extending from the wall section 17 is characterized by a central section 17′ extending approximately parallel to the limb 2′″ and a further thinner-walled section 17″ completing the hollow profile of the sealing section 1 in the direction of the limb 2″, relative to the central section 17′.

The wall section 17 extends from its connecting region with the central section 17′ upwards at an angle from the limb 2′″. As the ventilation hole 18 is, therefore, located in the base 19′ of the recess 19, this also contributes to the fact that said ventilation hole is hardly noticeable.

The fastening section 2, as well as the strip 3, may be produced from soft rubber, whereas the main part of the sealing section 1, consisting of the section 17″, the central section 17′ and the wall section 17 consists of cellular rubber. The entire sealing profile consisting of said two materials, as well as the reinforcement 4, may be produced in a continuous process in the manner of coextrusion.

The external region 20 of the sealing section is generally covered with a lubricating lacquer.

The limits of the aforementioned regions of the sealing section 1 and the fastening section 2 produced from different materials are respectively denoted at 21, 22.

Finally, at 23 a fiber is denoted which is incorporated in the substance of the fastening part.

It is recognized with reference to the aforementioned embodiments that the weatherstrip according to the invention, in addition to a reliable fastening on a peripheral edge flange, has a mechanically stable tubular sealing section, the outer appearance thereof not being impaired by ventilation openings.

As a result of the particular arrangement of the ventilation openings in connection with the remaining design of the sealing section 1, moreover, no substantial mechanical weakness of the sealing section results therefrom, so that placing said sealing profile along small radii of curvature is also possible without a negative effect. In particular, a collapse of the hollow profile of the sealing section is reliably prevented.

The use of filling pieces, which may be inserted into the sealing section 1 in order to stabilize said sealing section in terms of its shape, when bent along small radii, may therefore be substantially eliminated.

1. A weatherstrip for edging the opening of a vehicle or a door cooperating with such an opening, consisting at least of a U-shaped fastening section (2) intended for positioning on a flange fixedly connected to the edge, as well as a hollow profile-like sealing section (1) fixedly connected to the fastening section (2), provided with ventilation holes (18), the cross-sectional profile of the sealing section (1) being partially formed by the one facing limb (2′″) of the fastening section (2), which is completed by other wall sections (17, 17′, 17″) of the sealing section (1) to form an entire hollow profile, the ventilation openings (18) being located on the underside (1′) of the weatherstrip facing the aforementioned edge, characterized in that the wall thickness of the sealing section (1) consisting of the thick-walled wall section (17) attached to the limb (2′″), the central wall section (17′) extending parallel to the limb (2′″) and the further wall section (17″) completing the sealing section in combination with the limb (2′″) to form the hollow profile, which is thinner-walled relative to the central wall section (17′), is not uniform, in that the ventilation openings (18) are located in the wall section (17) having the greatest wall thickness, and in that on the sealing section (1) and namely on the side thereof facing the underside (1′) a rib (16′) is formed, which together with the limb (2′″) defines a U-shaped recess (19) open toward the underside (1), the ventilation holes (18) being located in the profile base (19′) thereof.

2. The weatherstrip as claimed in claim 1, characterized in that the wall section (17) extends upwards relative to the underside (1′) in a direction toward the limb (2′″).

3. The weatherstrip as claimed in claim 1, characterized in that on the fastening section (2) and namely on the side thereof opposing the sealing section (1), a strip (3) is formed which together with the limb (2′) of the fastening section (2) circumscribes a cavity (9″) open toward the underside (1).

4. The weatherstrip as claimed in claim 1, characterized in that at least the fastening section (2) consists of soft rubber.

5. The weatherstrip as claimed in claim 3, characterized in that the strip (3) is configured in the same material as the fastening section (2).

6. The weatherstrip as claimed in claim 1, characterized in that a preferably metal reinforcement (4) is incorporated in the U-shaped structure of the fastening section (2).

7. The weatherstrip as claimed in claim 1, characterized in that the sealing section (1) consists at least partially of cellular rubber.

8. The weatherstrip as claimed in claim 1, characterized in that the outer region (20) of the sealing section (1) is coated with lubricating lacquer or a coating having substantially the same effect.

9. The weatherstrip as claimed in claim 2, characterized in that on the fastening section (2) and namely on the side thereof opposing the sealing section (1), a strip (3) is formed which together with the limb (2′) of the fastening section (2) circumscribes a cavity (9″) open toward the underside (1′).

10. The weatherstrip as claimed in claim 2, characterized in that at least the fastening section (2) consists of soft rubber.

11. The weatherstrip as claimed in claim 3, characterized in that at least the fastening section (2) consists of soft rubber.

12. The weatherstrip as claimed in claim 4, characterized in that the strip (3) is configured in the same material as the fastening section (2).

13. The weatherstrip as claimed in claim 2, characterized in that a preferably metal reinforcement (4) is incorporated in the U-shaped structure of the fastening section (2).

14. The weatherstrip as claimed in claim 3, characterized in that a preferably metal reinforcement (4) is incorporated in the U-shaped structure of the fastening section (2).

15. The weatherstrip as claimed in claim 4, characterized in that a preferably metal reinforcement (4) is incorporated in the U-shaped structure of the fastening section (2).

16. The weatherstrip as claimed in claim 5, characterized in that a preferably metal reinforcement (4) is incorporated in the U-shaped structure of the fastening section (2).

17. The weatherstrip as claimed in claim 2, characterized in that the sealing section (1) consists at least partially of cellular rubber.

18. The weatherstrip as claimed in claim 3, characterized in that the sealing section (1) consists at least partially of cellular rubber.

19. The weatherstrip as claimed in claim 2, characterized in that the outer region (20) of the sealing section (1) is coated with lubricating lacquer or a coating having substantially the same effect.

20. The weatherstrip as claimed in claim 3, characterized in that the outer region (20) of the sealing section (1) is coated with lubricating lacquer or a coating having substantially the same effect.
